(19) United States
(12) Patent Application Publication
(10) Pub. No.: US 2007/0079670 A1
(43) Pub. Date: Apr. 12, 2007

(54) Cap wrench

(76) Inventors: Peter C. Chaconas, Glyndon, MD (US); Brian Quirk, West Hartford, CT (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/338,358

(22) Filed: Jan. 24, 2006

Related U.S. Application Data
(63) Continuation-in-part of application No. 29/236,434, filed on Aug. 16, 2005.

(51) Int. Cl. B67B 7/16; B67B 7/44

(52) U.S. Cl. 81/3.55; 81/3.09

(57) ABSTRACT

A cap wrench is provided to enable a user to more easily and safely remove bottle caps from a bottle. The cap wrench includes a handle and a recess that engages the capped end of a bottle. When the capped end of a bottle is inserted into the recess, the cap wrench is capable of opening the bottle by either pulling up or pushing down on the handle. A fulcrum locus also is provided inside the recess to further ease the removal of the cap from a bottle by providing a pivot point about which the cap wrench may be turned. Additionally, a prying ridge is also provided inside the recess, whereby opening forces are applied to the bottle cap.

This is a continuation-in-part of U.S. Design Application Serial No. 29/236,434, filed Aug. 16, 2005, the entire disclosure being incorporated by reference herein.

### BACKGROUND OF THE INVENTION

The present invention relates generally to bottle openers, and more particularly to a bottle opener that utilizes the aesthetic appearance and mechanical advantages of a wrench.

Bottle caps are applied to the open end of a bottle during the capping portion of the bottling process. Capping typically involves placing a bottle cap onto the open end of a bottle and crimping the cap onto the bottle, which seals the bottle and protects the contents of the bottle from contamination and spillage. Caps may be crimped so as to form either a twist-off cap or a standard pry-off cap. The pry-off type caps require the use of a tool to remove the cap from the bottle. While twist-off caps do not require a tool for removal, the crimping process can result in the formation of sharp metal edges on the cap. Accordingly, the safest manner to remove a bottle cap, whether twist-off or pry-off, is to use a bottle opener.

Previously, bottle caps have been removed by a multiplicity of tools, some specifically designed for the task of opening bottles, such as conventional bottle openers. While any number of tools may be useful in opening a bottle, a common problem is that the torque and force necessary to remove the cap from the bottle often result in a jerking motion as the bottle cap is pried from the bottle. This jerking motion can result in spillage of the contents and creates the potential for the user to drop the bottle altogether.

### SUMMARY

The present invention recognizes and addresses considerations of prior art constructions and methods and provides a cap wrench that allows a user to easily remove the cap from a bottle.

In one embodiment of the present invention, the cap wrench has a handle, a head connected to one end of the handle, and a bore located at the end of the handle opposite the head. The head is comprised of an end wall and a sidewall. The end wall has a top surface and a bottom surface, and is generally oblong in shape. The sidewall has an inner surface and an outer surface. The outer surface of the sidewall generally follows the contour of the end wall's oblong shape, while the inner surface of the sidewall and the bottom surface of the end wall together define a generally cylindrical bottle recess. The bottom surface of the end wall further defines a fulcrum locus, which projects away from the bottom surface toward the center of the bottle recess. The inner sidewall surface further defines at least one prying ridge, which projects inward toward the center of the bottle recess. The end wall and the sidewall are sized appropriately to receivably accept the capped end of a bottle and withstand the forces exerted during the opening of a bottle.

When the capped end of a bottle is inserted into the bottle recess, the prying ridge engages the bottle cap by sliding under the flange of the bottle cap. The fulcrum locus simultaneously engages the flat surface of the bottle cap. When the cap wrench engages a bottle cap in this manner, a force applied to the handle of the cap wrench in either an upward or downward direction will result in a moment about the pivot point. This moment will result in prying ridge imparting an upward force on the flange of the metal bottle cap. When the force imparted on the flange of the cap exceeds the mechanical strength of the bottle cap, the bottle cap will deform, and the cap wrench will pry the bottle cap off the bottle.

In another embodiment, the cap wrench is capable of twisting a twist-off style bottle cap from a bottle. In this embodiment, the head has an end wall that is generally circular in shape. The head's sidewall defines prying ridges, which further define inner edges having multiple serrations. The inner edges are the portions of the prying ridges located closest to the center of the bottle recess. The head is sized appropriately so that when the capped end of a bottle is inserted into the bottle recess, both prying ridges engage the bottle cap flange, and the serrations on the prying ridge receivably accept the crimped edges on bottle cap flange that result from the crimping process. Thus, the cap wrench can be rotated about a central longitudinal axis of the bottle, thereby twisting the bottle cap off of the bottle, just as a wrench turns a workpiece.

In another embodiment, the cap wrench is capable of easily opening a can with a pull-tap style opener. In this embodiment, the head sidewall further defines a tab slot. The tab slot is located on the portion of the sidewall distal from the cap wrench handle, along the central-longitudinal axis of the cap wrench handle. The tab slot is positioned at the intersection between the sidewall and the end wall bottom surface, and proceeds through the entire thickness of the sidewall. The tab slot is shaped so as to receivably accept the pull-tab from a metal can. Once the pull-tab is inserted into the tab slot, prying up on the cap wrench handle will lift the pull tab, thereby opening the can.

The accompanying drawings, incorporated in and constituting part of this specification, illustrate one or more of the embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification and makes reference to the appended drawings, where:

FIG. 1 is a top perspective view of a cap wrench in accordance with an embodiment of the present invention;

FIG. 2 is a bottom perspective view of the opposite side of the wrench shown in FIG. 1;

FIG. 3 is a right side elevation view of the cap wrench shown in FIG. 1;

FIG. 4 is a top plan view of the cap wrench shown in FIG. 1;

FIG. 5 is a bottom plan view of the cap wrench shown in FIG. 1;

FIG. 6 is an end-on view of the cap wrench shown in FIG. 1;

FIG. 7 is an end-on view of the cap wrench shown in FIG. 1;

FIG. 8 is a bottom plan view of a cap wrench in accordance with an embodiment of the present invention;

FIG. 9 is a bottom perspective view of the cap wrench shown in FIG. 8;

FIG. 10 is a right side cut-away view of the cap wrench shown in FIG. 1;

FIG. 11 is a right side cut-away view of the cap wrench shown in FIG. 8;

FIGS. 12-15 are right side cut-away views of the cap wrench shown in FIG. 8, depicting the cap wrench being used on a bottle cap;

FIGS. 16-19 are right side cut-away views of the cap wrench shown in FIG. 8, depicting the cap wrench being used on a bottle cap;

FIG. 20 is a bottom perspective view of a cap wrench in accordance with an embodiment of the present invention;

FIG. 21 is a close-up bottom perspective view of the cap wrench shown in FIG. 20;

FIG. 22 is a right side cut-away view of the cap wrench shown in FIG. 20;

FIGS. 23-26 are right side cut-away views of the cap wrench shown in FIG. 20, depicting the cap wrench being used on a bottle cap;

FIGS. 27-29 are right side cut-away views of the cap wrench shown in FIG. 20, depicting the cap wrench being used on a bottle cap;

FIGS. 30-32 are bottom plan views of the cap wrench shown in FIG. 20, depicting the cap wrench being used on a bottle cap;

FIG. 33 is a bottom perspective view of a cap wrench in accordance with an embodiment of the present invention;

FIG. 34 is an end-on view of the cap wrench shown in FIG. 33;

FIG. 35 is a is a right side cut-away view of the cap wrench shown in FIG. 33;

FIG. 36 is a is a right side cut-away view of the cap wrench shown in FIG. 33; and

FIGS. 37-38 are perspective views of the cap wrench shown in FIG. 33, depicting the cap wrench being used on a can tab.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, is intended that the present invention covers such modifications and variations as come within the scope of the appended claims and their equivalents.

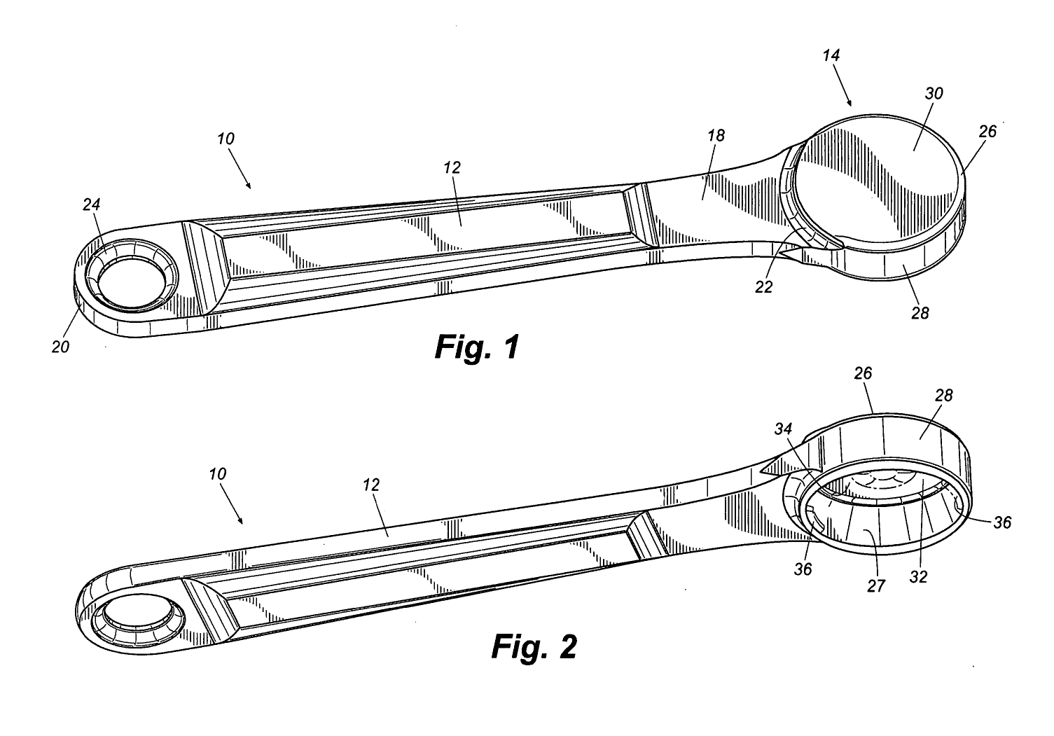

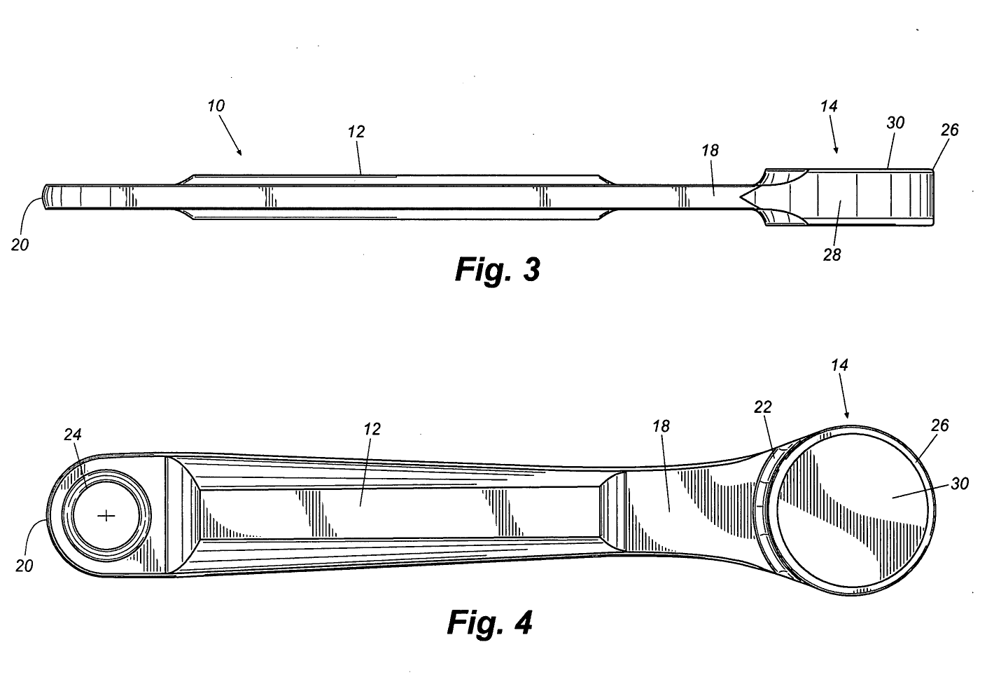

Referring to the drawings, and particularly to FIGS. 1-4, a cap wrench 10 has a body with a handle 12 and a head generally denoted 14. The body may be formed from any suitable material, for example one or a combination of steel, alloy, ceramics, polymers, etc. A first end 18 defines head 14, and a second end 20 defines handle 12. Head 14 is integrally formed with handle 12 by a neck 22. Second end 20 has a bore 24 formed therethrough that allows for easy storage of cap wrench 10 when not in use. Instead of bore 24, other means of storing cap wrench 10 may be provided. Neck 22 tapers smoothly from the top and bottom of head 14 into handle 12 (FIG. 6), so as to reduce the amount of material required to manufacture cap wrench 10 without reducing its strength.

Head 14 has a sidewall 28 and an end wall 26, which is bounded by a top surface 30 and a bottom surface 32. Referring particularly to FIG. 2, an inner surface 27 of sidewall 28 and end wall bottom surface 32 define a generally cylindrical recess 34. A prying ridge 36 projects radially inward from sidewall inner surface 27 toward the center of recess 34. In one embodiment, two prying ridges 36 are located on opposite sides of the sidewall inner surface 27 and are aligned such that they are generally parallel to handle 12. IT should be understood that prying ridges 36 may be slightly angled upward to better grasp the edge of the bottle cap.

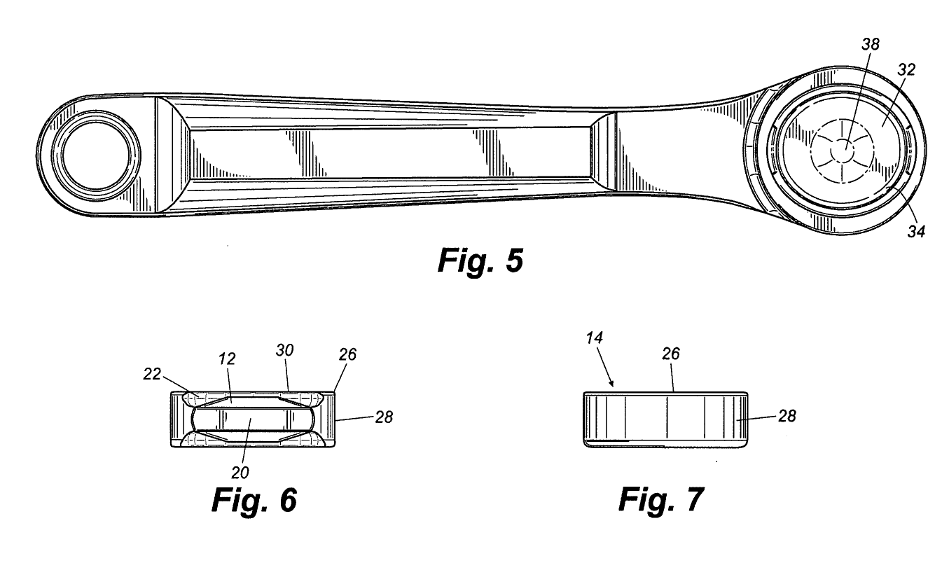

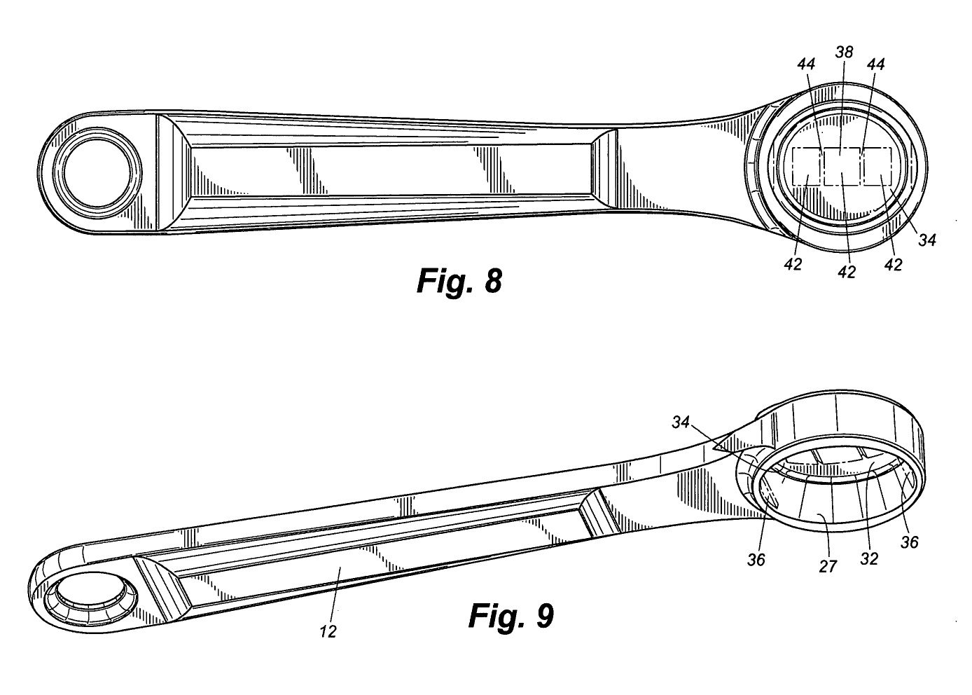

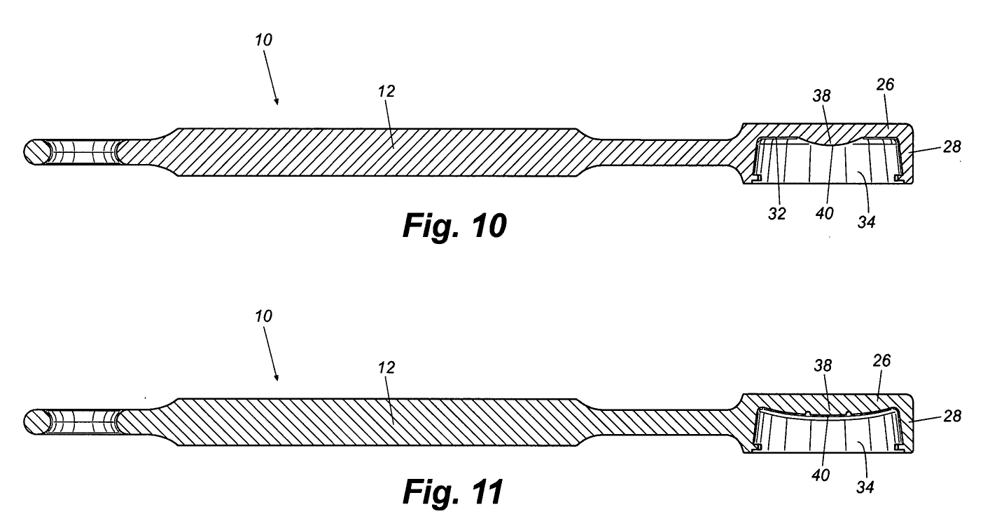

Referring to FIGS. 5, 8, 10, and 11, a fulcrum locus 38 projects axially downward from bottom surface 32 toward the center of generally cylindrical recess 34. In one embodiment, a cross-section of fulcrum locus 38, along a longitudinal axis of handle 12, has a profile 40 that is convex (FIGS. 5 and 10). In this embodiment, fulcrum locus profile 40 may be understood to be simply convex, quasi-spherical, parabolic or otherwise similarly shaped. In another embodiment, fulcrum locus 38 may have a discontinuously convex profile 40 (FIGS. 8, 9 and 11). In this embodiment, fulcrum locus profile 40 is defined by raised ridges 42, the raised ridges 42 being separated from each other by channels 44 (FIG. 8). Raised ridges 42 are preferably narrow in width transverse to the handle axis so that the point of contact between raised ridges 46 and bottle cap 52 (FIG. 13) is generally limited to a location at the center of the circular flat surface 56 of bottle cap 52. However, raised ridges 42 may have a larger width so that the point of contact is linear across the entire diameter of flat surface 56. While, profile 40 is convex along the axis of handle 12, it does not have to be curved along an axis transverse to the handle axis.

The term “fulcrum locus,” as used herein, is defined as the portion of the end wall bottom surface that engages the flat surface of the bottle cap and about which the cap wrench pivots when an opening force is applied to the cap wrench handle. It should be understood that the point of contact between the end wall bottom surface and the bottle cap may translate during the course of opening the bottle cap. That is, because the fulcrum locus may be a curved surface and is not limited to a single point, the point of contact between the bottle cap and the fulcrum locus translates along the curved surface as the cap wrench rotates to open the bottle, much like the point of contact between a car tire and the road translates along both the road and the outer circumference of the tire as the tire rolls.

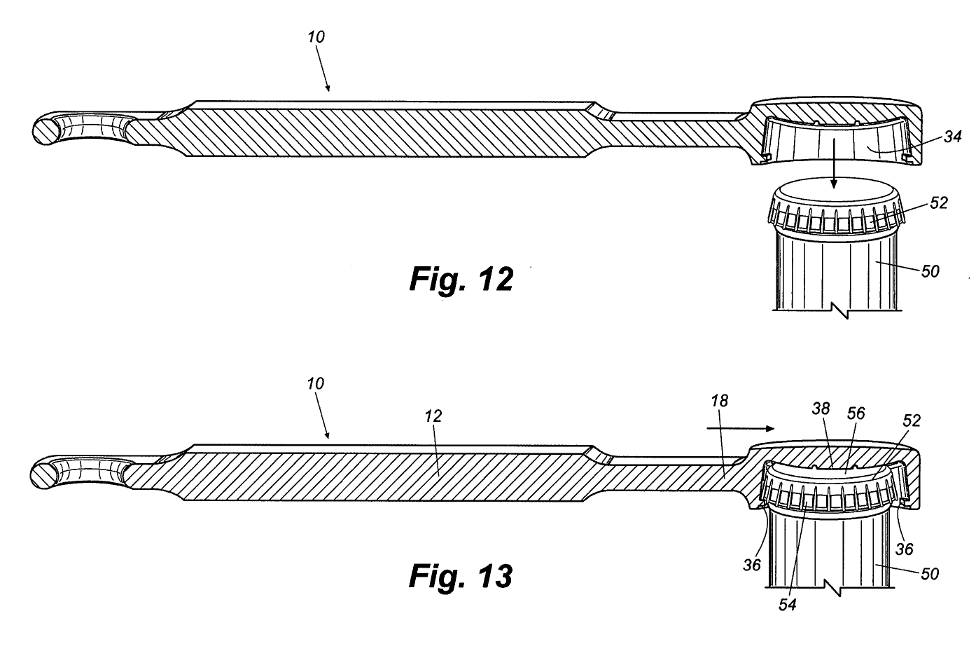

The operation of cap wrench 10 will now be described with reference to FIGS. 12-19. Referring first to FIG. 12, cap wrench 10 is shown initially positioned over the capped end of a bottle 50. Cap wrench 10 is then lowered so that recess 34 releasably receives bottle cap 52. Referring to FIG. 13, once the capped end of the bottle is received in the recess, cap wrench 10 may be pushed forward to position prying ridge 36, located proximate to handle first end 18, under flange 54. In this position, prying ridge 36, located distal from handle first end 18, will not make contact with bottle cap flange 54, and fulcrum locus 38 contacts a flat surface 56 of bottle cap 52.

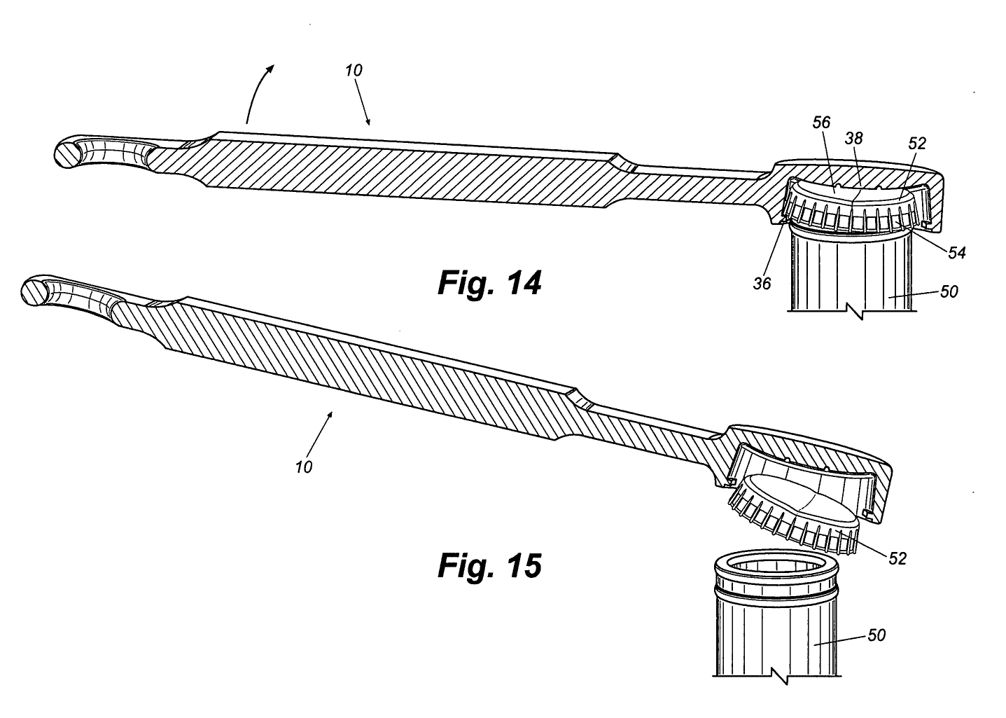

Referring to FIG. 14, second handle end 20 is rotated clockwise (with respect to FIG. 14) about the point of contact between fulcrum locus 38 and bottle cap flat surface 56, causing prying ridge 36 to exert an upward force on the underside of the bottle cap flange 54. Accordingly, fulcrum locus 38 exerts a downward force in the center of bottle cap flat surface 56 causing an oil canning effect on the bottle cap. As a result, the bottle cap 52 will begin to bend at the point of contact and separate from bottle 50. Referring to FIG. 15, once bottle cap 52 is completely separated from bottle 50, bottle cap 52 will fall away from cap wrench 10.

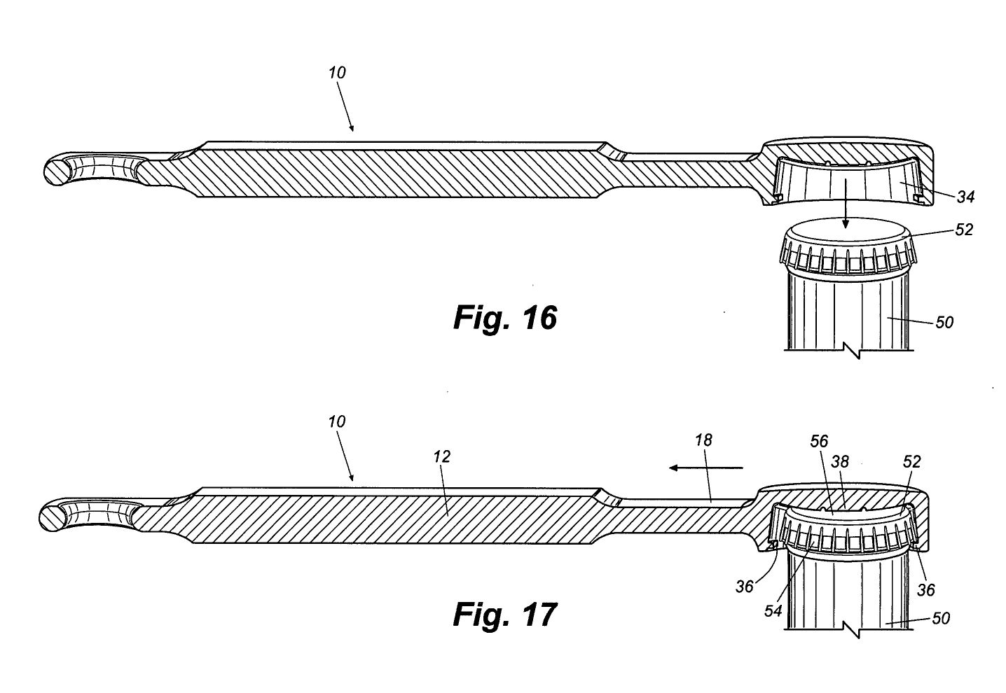

Cap wrench 10 may also be used in a manner that differs slightly from the use described above. Referring first to FIG. 16, cap wrench 10 is shown initially positioned over the capped end of a bottle 50. Cap wrench 10 is then lowered so that recess 34 releasably receives bottle cap 52. Referring now to FIG. 17, once the capped end of the bottle is received in the recess, cap wrench 10 may be pulled backward to position prying ridge 36, located distal from handle first end 18, under flange 54. In this position, prying ridge 36, located proximate to handle first end 18, will not make contact with bottle cap flange 54, and fulcrum locus 38 contacts a flat surface 56 of bottle cap 52.

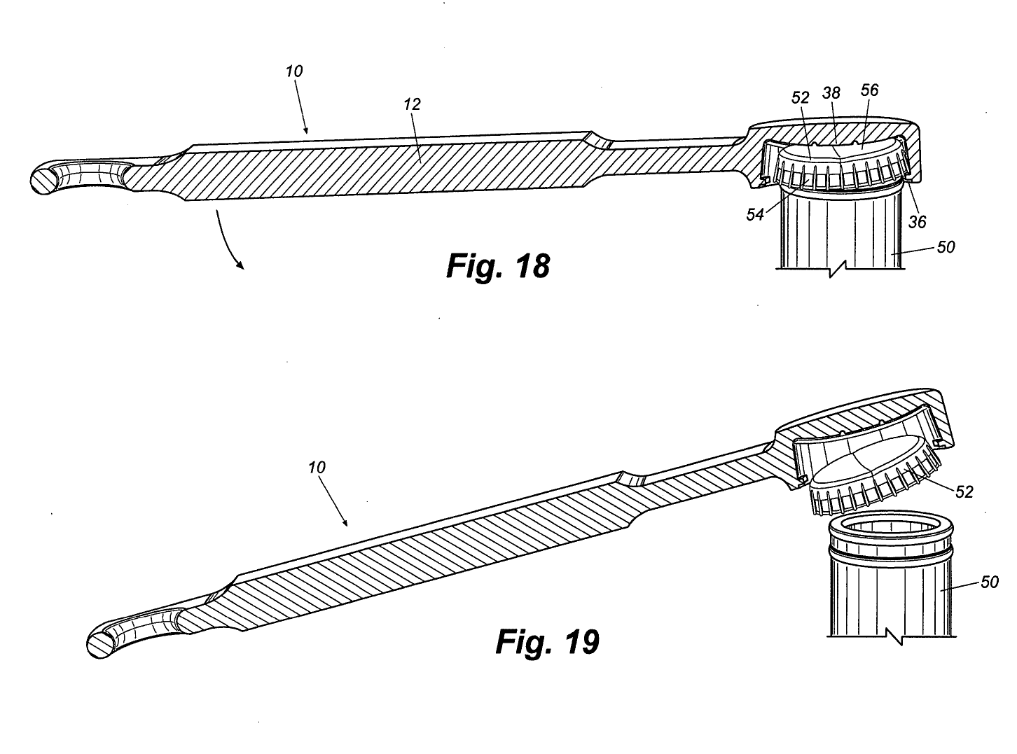

Referring to FIG. 18, second handle end 20 is rotated counterclockwise (with respect to FIG. 18) about the point of contact between fulcrum locus 38 and bottle cap flat surface 56, causing prying ridge 36 to exert an upward force on the underside of flange 54. Accordingly, fulcrum locus 38 exerts a downward force in the center of bottle cap flat surface 56 causing an oil canning effect on the bottle cap. As a result, the bottle cap 52 will begin to bend at the point of contact and separate from bottle 50. Referring to FIG. 19, once bottle cap 52 is completely separated from bottle 50, bottle cap 52 will fall away from cap wrench 10.

The design of cap wrench 10 represents an improvement over the prior art because prior art embodiments simply rely on deforming the flange of the bottle cap by exacting a radially outward force on the bottle cap flange. Thus, as one side of the flange is pried radially outward, the cap is pulled up and away from the bottle. The cap wrench of the present invention offers three distinct advantages over the prior art.

First, the elongated handle offers an extended moment arm, which requires the user to exert less force on the cap wrench to remove the bottle cap. This phenomenon, where a small force is applied to a tool, which thereby imparts a much larger force on a work piece, is generally known in the art as a “mechanical advantage.” The mechanical advantage of the cap wrench lessens the jerking effect typically associated with prying the cap free from the bottle, thereby reducing the likelihood of spillage or dropping the bottle.

Secondly, when multiple prying ridges are employed, the cap wrench offers the user the choice of whether to open the bottle by exerting an upward or downward force on the handle of the cap wrench. In either case, the cap wrench uses the same pivot point and retains its mechanical advantage.

The third and most significant advantage offered by the cap wrench's design is that the cap wrench promotes easy opening of a bottle by inducing an “oil-canning” effect on the bottle cap's flat surface. “Oil-canning” refers to the buckling of the bottle cap flat surface when a force is applied perpendicular to the center of the bottle cap's flat surface. The application of downward force to the center of the bottle cap creates tension on the bottle cap flat surface radially inward from the outer circumference of the bottle cap towards the center. When the applied force is large, the resulting tension causes the bottle cap flat surface to actually deform in a concave manner. Accordingly, the bottle cap flange rotates about the point of connection between the flat surface and the flange thereby expanding radially outward, and loosening.

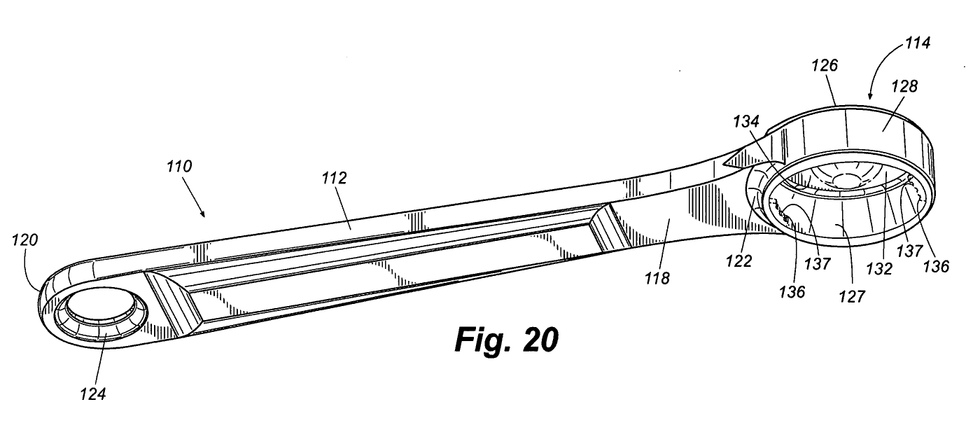

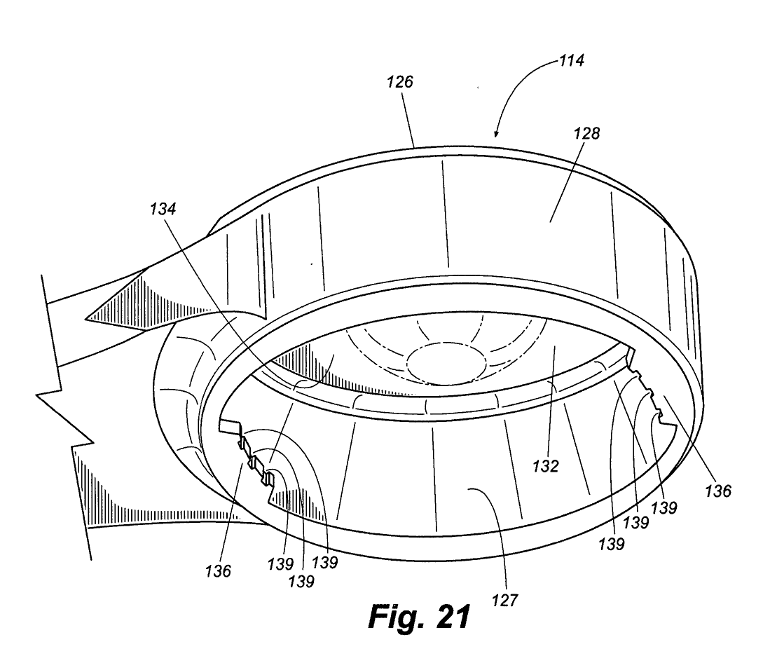

Another embodiment of the present invention will now be described with reference to FIGS. 20-32. Referring to FIGS. 20-22, a cap wrench 110 has a body with a handle 112 and a head generally denoted 114 (FIG. 21). A first end 118 defines head 114, and a second end 120 defines handle 112. Head 114 is integrally formed with handle 112 by a neck 122, and second end 120 has a bore 124 formed therethrough.

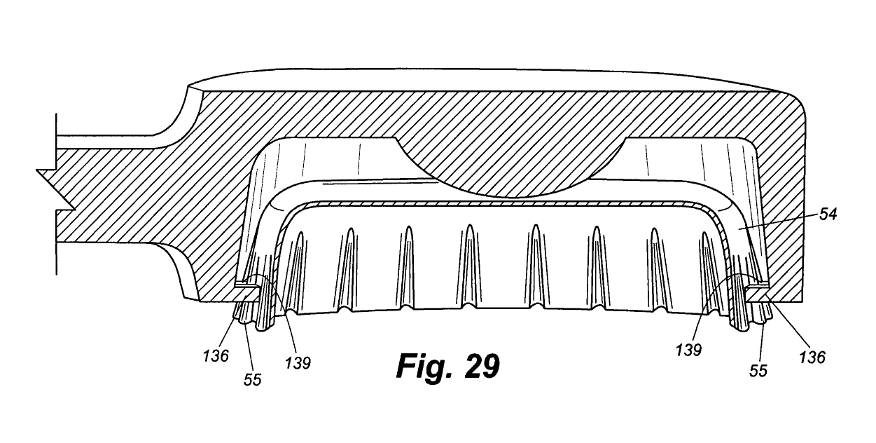

Head 114 has an end wall 126 having a bottom surface 132, and a sidewall 128 that defines an inner surface 127. End wall bottom surface 132 and sidewall inner surface 127 define a generally cylindrical recess 134. Two prying ridges 136 are located on opposite sides of the sidewall inner surface 127 and have radially inwardly pointing edges 137 (FIG. 20). A diameter between radially inwardly pointing edges 137 is substantially equal to a radius of bottle cap 52. In one embodiment, prying ridges 136 are aligned such that they are generally parallel to handle 112, but they may be angled slightly upward to better grasp the edge of the bottle cap. Additionally, prying ridges 136 define serrations 139 formed along edges 137 (FIG. 21). Serrations 139 are spaced so as to receivably accept the crimped ridges 55 of bottle cap flange 54 (FIG. 29).

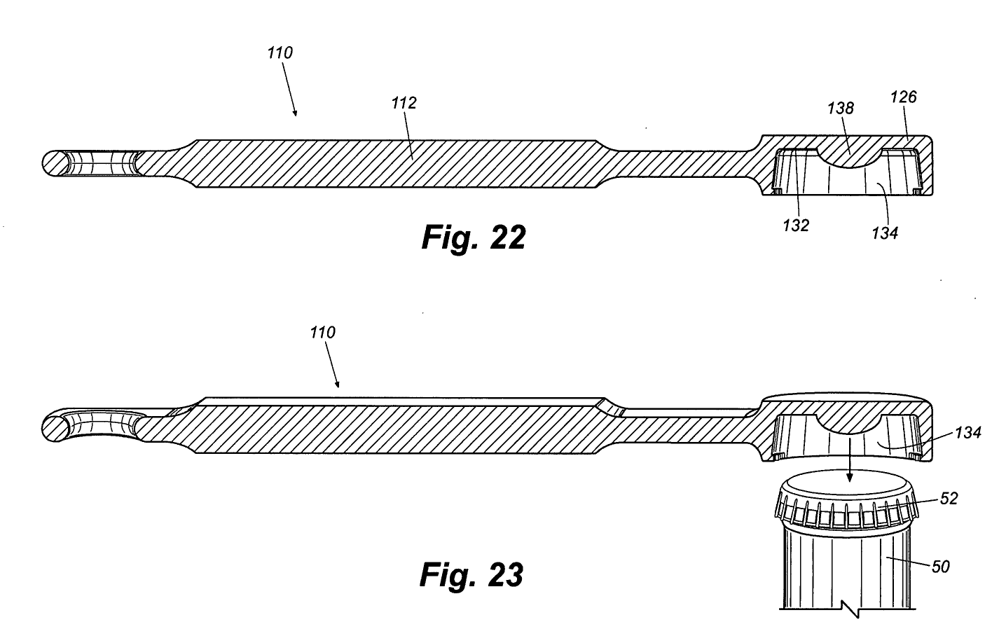

Referring to FIG. 22, a fulcrum locus 138 projects axially downward from end wall bottom surface 132 toward the center of generally cylindrical recess 134. Fulcrum locus 138 may be formed similar to that described with respect to the embodiments shown in FIGS. 5, 8, 10 and 11. However, in the current embodiment, the depth of fulcrum locus 138 is increased so that the cap wrench may be used in several configurations, as described in further detail below.

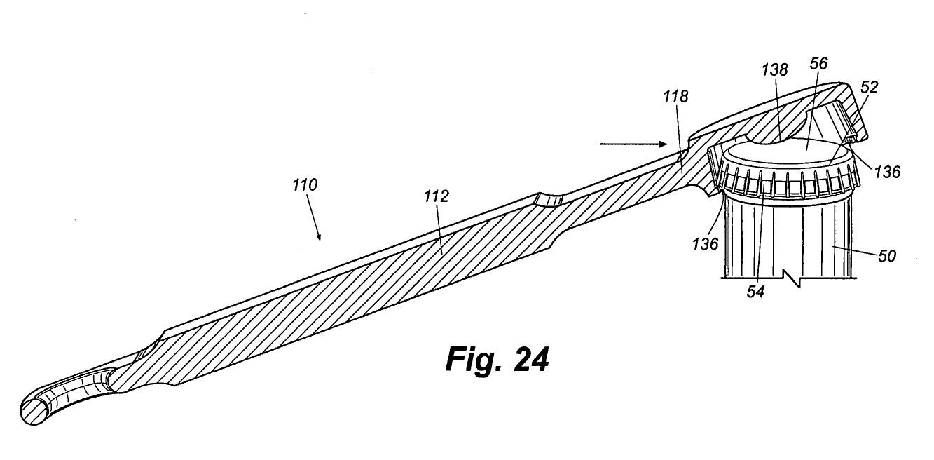

One method of operation of cap wrench 110 will now be described with reference to FIGS. 23-26. Referring first to FIGS. 23 and 24, cap wrench 110 is shown initially positioned over the capped end of bottle 50 and is lowered and angled with respect to bottle cap 52 such that recess 134 receives bottle cap 52. Because the diameter between the prying ridges is substantially equal to the diameter of bottle cap 52, only a portion of the bottle cap can fit into recess 134. To accommodate this arrangement, the depth of fulcrum locus 138 is increased so that it contacts bottle cap flat surface 56 when only a portion of bottle cap 52 is received in the recess. Once in this position, cap wrench 110 is pushed forward to position prying ridge 136, located proximate to handle first end 118, into contact with the underside of bottle cap flange 54.

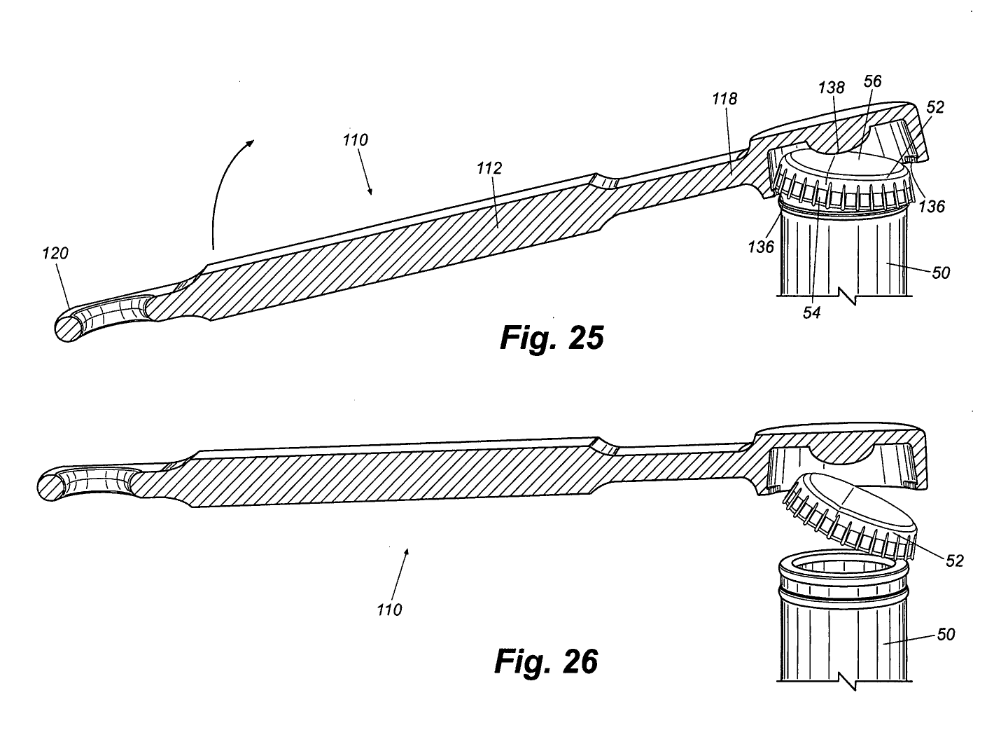

Referring to FIG. 25, an upward force is applied to second handle end 120 causing the handle to pivot clockwise about the point of contact between fulcrum locus 138 and bottle cap flat surface 56. The downward force applied to bottle cap flat surface 56 by fulcrum locus 138 causes the oil canning effect on the bottle cap. Accordingly, bottle cap 52 loosens, and bottle cap 52 begins to separate from bottle 50. Referring now to FIG. 26, once bottle cap 52 is completely separated from bottle 50, bottle cap 52 will fall away from cap wrench 110. It is important to note that as in prior embodiments, cap wrench 110 may be positioned such that prying ridge 136, located distal from handle 112, makes contact with bottle cap flange 54. In this arrangement, bottle cap handle 112 is rotated counterclockwise, thereby removing bottle cap 52 from bottle 50, as previously described above.

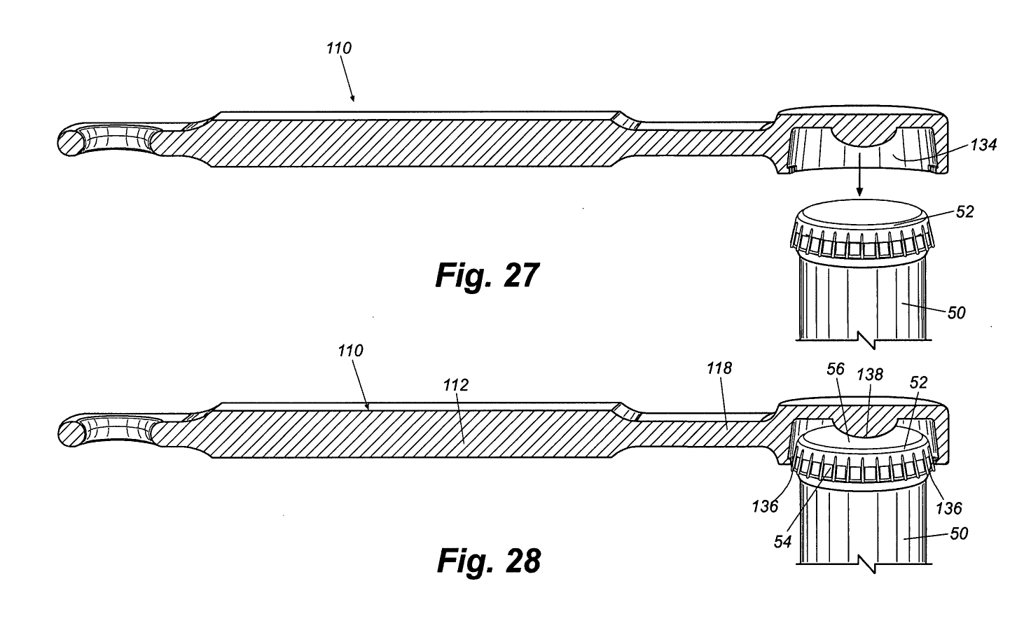

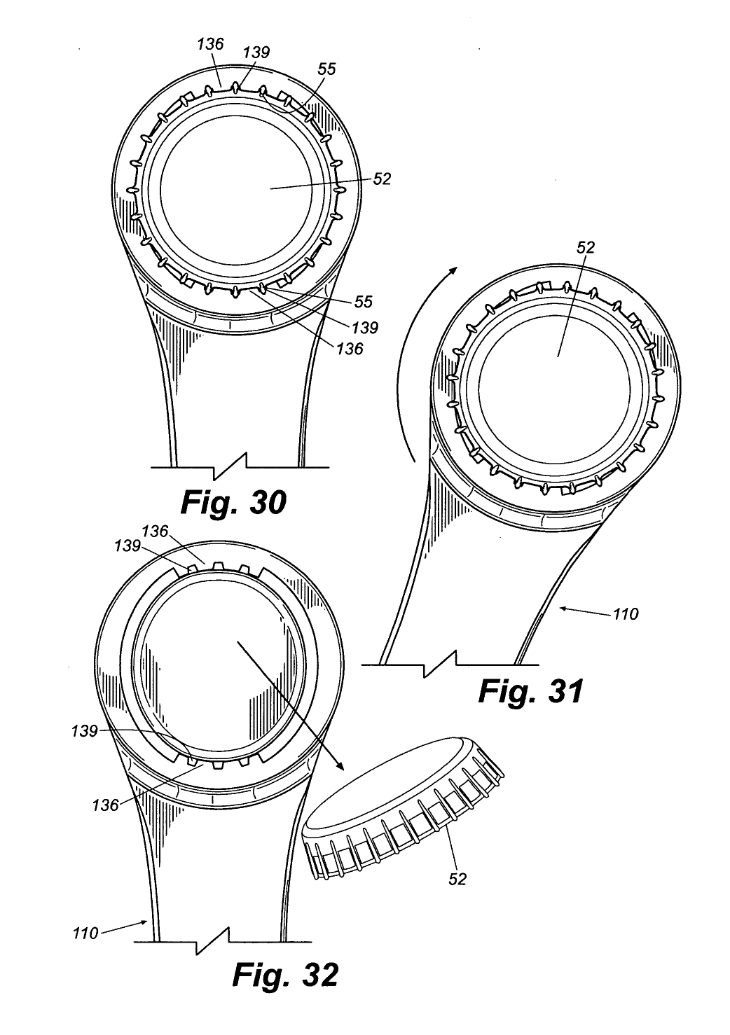

Referring now to FIGS. 27-28, cap wrench 110 is shown operating on a twist off type bottle cap. Initially, cap wrench 110 is positioned over the capped end of a bottle 50 such that end wall 126 is substantially parallel to bottle cap flat surface 56. Cap wrench 110 is then lowered so that recess 134 may receivably accept bottle cap 52 between prying ridges 136. Referring to FIGS. 29-30, prying ridges 136 engage the outer circumference of bottle cap flange 54 so that serrations 139 engage bottle cap flange crimped edges 55. The cap wrench is positioned on the end of the bottle so that fulcrum locus 138 engages bottle cap flat surface 56. Referring to FIG. 31, cap wrench 110 may be rotated clockwise with respect to a longitudinal axis of the bottle in FIG. 31 while the user holds the bottle rotationally fixed. In this configuration, bottle cap 52 begins to twist off from bottle 50 (not shown) and once free from bottle 50 (not shown), bottle cap 52 will fall away from cap wrench 110 (FIG. 32).

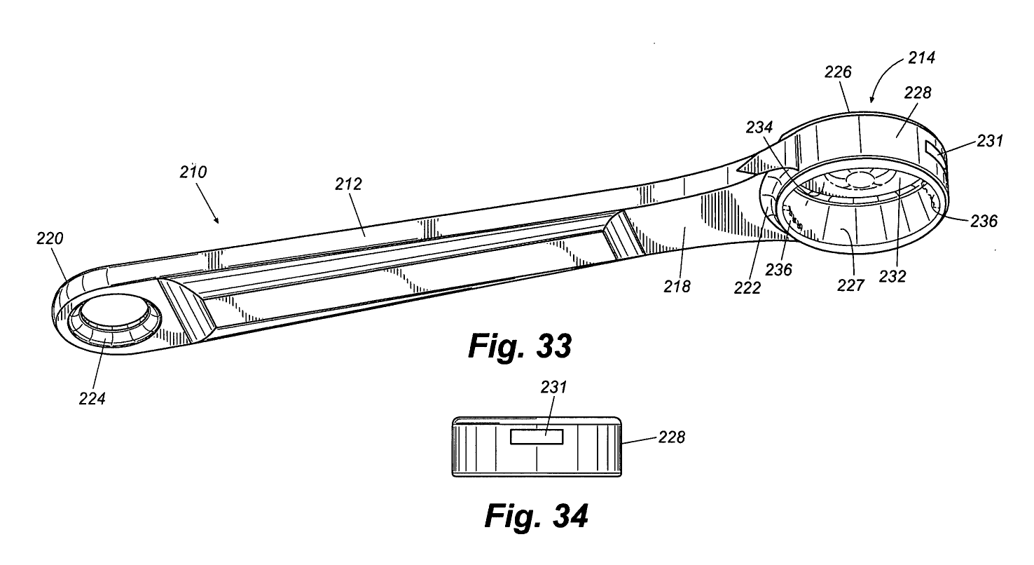

Another embodiment of the cap wrench of the present invention will be described with reference to FIGS. 33-38. Referring to FIG. 33, a cap wrench 210 has a body with a handle 212 and a head generally denoted 214. A first end 218 defines head 214, and a second end 220 defines handle 212. Head 214 is integrally formed with handle 212 by a neck 222, and second end 220 has a bore 224 formed therethrough.

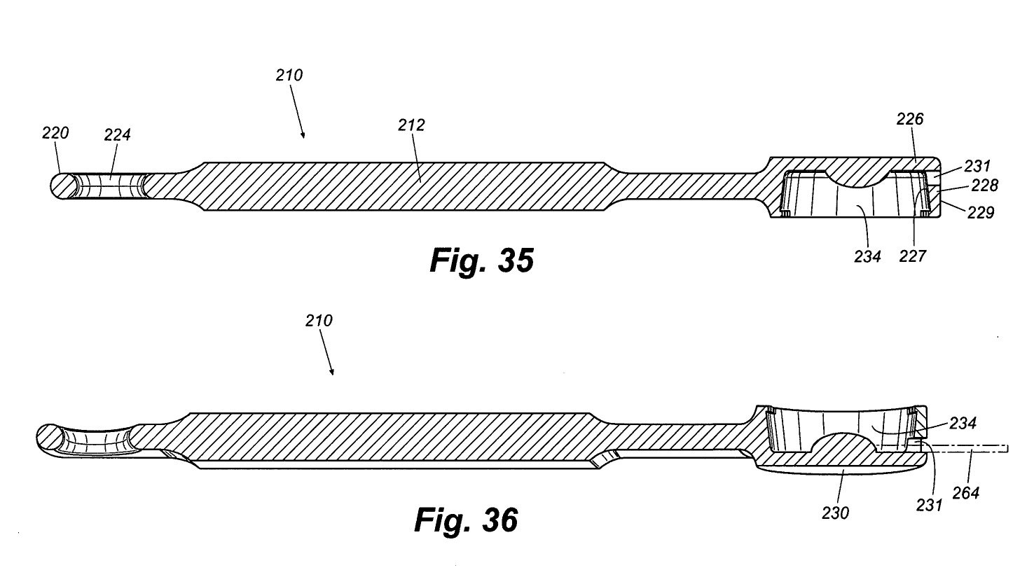

Head 214 has an end wall 226 and a sidewall 228. End wall 226 defines a top surface 230 (FIG. 36) and a bottom surface 232, and sidewall 228 defines inner surface 227 and an outer surface 229 (FIG. 35). End wall bottom surface 232 and sidewall inner surface 227 together define bottle recess 234. Referring to FIGS. 34 and 35, sidewall 228 defines a tab slot 231 that is preferably positioned at or near the intersection between sidewall 228 and end wall 226. Tab slot 231 is generally rectangular in shape and extends through the end wall between sidewall outer surface 229 and sidewall inner surface 227, and top and bottom slot walls are generally aligned parallel to the longitudinal axis of handle 212. However, it should be recognized that tab slot 231 may take on a shape other than rectangular and may be located anywhere on sidewall 228 or at handle second end 220, replacing bore 224 as a means of storing cap wrench 210.

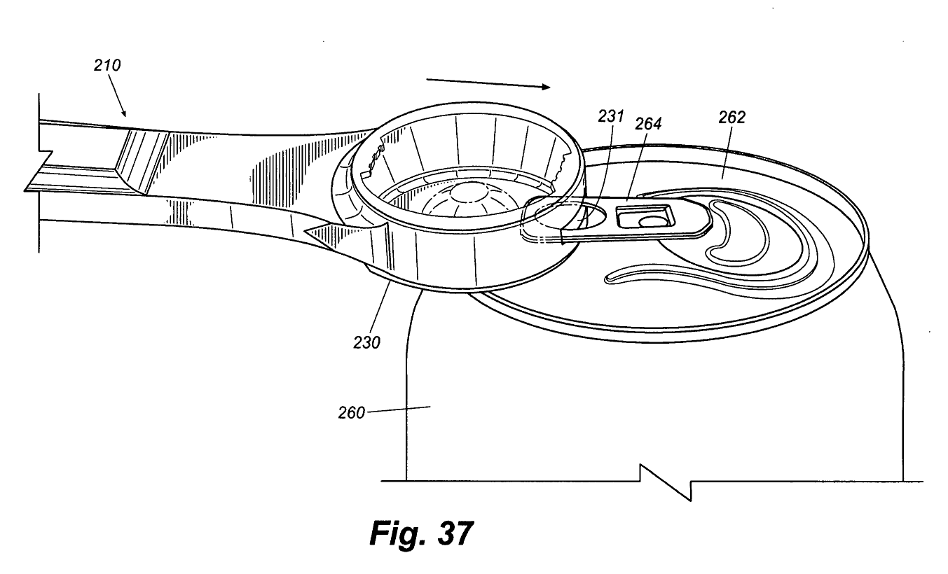

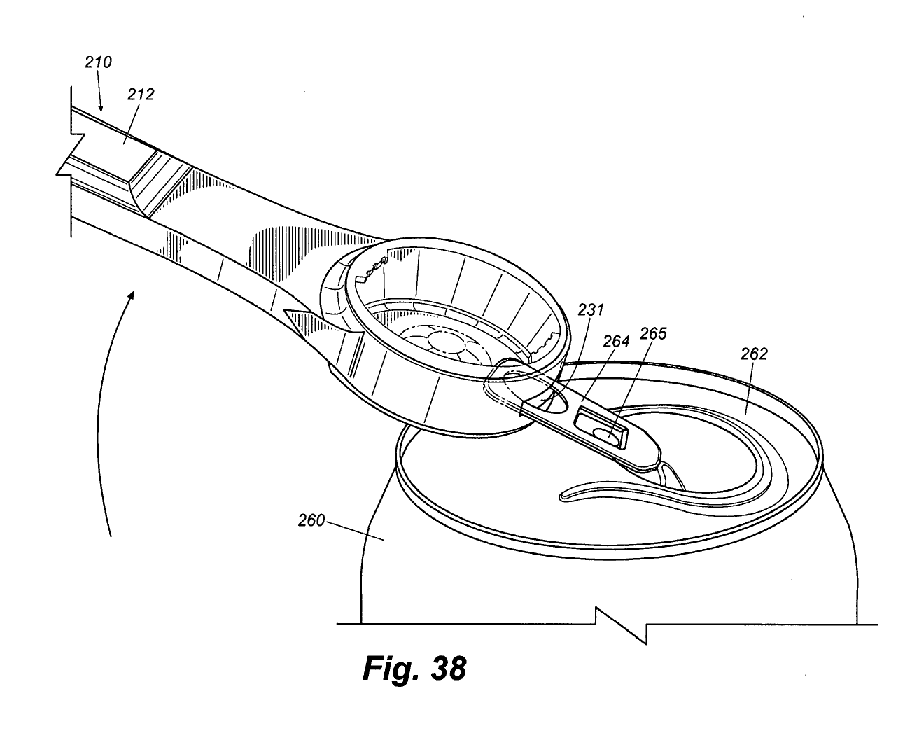

The operation of cap wrench 210 is described with reference to FIGS. 36-38. FIG. 36 shows cap wrench 210 positioned so that bottle recess 234 is facing upward, and a pull tab 264, represented by a dashed line, is receivably accepted by slot 231. FIG. 37 illustrates cap wrench 210 positioned so end wall 230 rests on a top edge of a can 260. Referring to FIG. 38, rotating cap wrench handle 212 clockwise with respect to FIG. 38 causes cap wrench 210 to pivot off the can's top edge and pry pull tab 264 about the pull tab connection point 265. Thus, the engagement between tab slot 231 and pull tab 264 rotates pull tab 264, thereby opening can 260.

While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to the embodiments disclosed herein since modifications can be made. Specifically, prying ridge 36 of cap wrench 10 (FIG. 2) may define serrations 139 for receivably accepting crimped edges 55 from bottle cap flange 54. Additionally, sidewall 28 may define tab slot 231 as a feature on cap wrench 10 (FIG. 2), or, alternatively, sidewall 128 of cap wrench 110 may define tab slot 231 (FIG. 20). Therefore, it is contemplated that any and all such embodiments fall within the scope and spirit thereof.

What is claimed:

1. A cap wrench, said cap wrench comprising:
a. a handle having:
a first end,
a second end; and
b. a head connected to said first end of said handle, said head having:
an end wall defining a top surface and a bottom surface,
a sidewall defining an inner surface and an outer surface, said sidewall inner surface and said end wall bottom surface cooperating to define a generally cylindrical recess for receivably accepting a capped end of a bottle, and
at least one prying ridge that projects radially inward from said sidewall inner surface towards a center of said head recess.

2. The cap wrench of claim 1, wherein said bottom surface cooperates with a flat surface of a bottle cap, such that contact between said bottom surface and the bottle cap flat surface creates a pivot point, about which said cap wrench may rotate when removing the bottle cap.

3. The cap wrench of claim 2, wherein said at least one prying ridge cooperates with a flange portion of the bottle cap, such that when said cap wrench is rotated about said pivot point, said prying ridge pries up on the flange portion of the bottle cap causing the bottle cap flat surface to crease.

4. The cap wrench of claim 1, wherein said at least one prying ridge defines a multiplicity of serrations for receivably accepting the crimped edges of the flange portion of a bottle cap.

5. The cap wrench of claim 1, further comprising a tab slot for receivably accepting the pull-tab of a metal can.

6. A cap wrench, said cap wrench comprising:
a. a handle having:
a first end,
a second end, and
a central longitudinal axis therethrough extending from said first end to said second end; and
b. a head connected to said first end of said handle, said head having:
an end wall defining a top surface and a bottom surface,
a sidewall defining an inner surface and an outer surface, said sidewall inner surface and said end wall bottom surface cooperating to define a generally cylindrical recess for receivably accepting a capped end of a bottle,
a fulcrum locus extending axially from said end wall bottom surface into said recess, and
at least one prying ridge projecting radially inward from said sidewall inner surface toward a center of said head recess, said prying ridge having a midpoint.

7. The cap wrench of claim 6, wherein said fulcrum locus cooperates with a flat surface of a bottle cap, such that the point of contact between said fulcrum locus and a bottle cap flat surface defines a pivot point, about which said cap wrench rotates when removing the bottle cap, and about which the bottle cap is bent when opening the bottle.

8. The cap wrench of claim 6, wherein said at least one prying ridge is positioned such that said midpoint of said prying ridge is aligned along said handle central longitudinal axis.

9. The cap wrench of claim 6, wherein said at least one prying ridge defines multiple serrations, said multiple serrations cooperating with the crimped edges of a bottle cap when the capped end of a bottle is inserted into said head recess.

10. The cap wrench of claim 6, further comprising a tab slot for receivably accepting the pull-tab of a metal can.

11. A cap wrench, said cap wrench comprising:
a. a handle having:
a first end,
a second end, and
a central longitudinal axis therethrough; and
b. a head connected to said first end of said handle, said head having:
an end wall, said end wall having a bottom surface,
a sidewall, said sidewall defining an inner surface and an outer surface, said sidewall inner surface and said end wall bottom surface cooperating to define a generally cylindrical recess for receivably accepting the capped end of a bottle,
a first prying ridge projecting radially inward from said sidewall inner surface toward a center of said head recess, said first prying ridge having a midpoint and an inner edge, and
a second prying ridge, projecting radially inward from said sidewall inner surface toward said center of said head recess, said second prying ridge having a midpoint and an inner edge.

12. The cap wrench of claim 11, wherein said first prying ridge and said second prying ridge are arranged generally opposite each other, said midpoint of said first prying ridge and said midpoint of said second prying ridge being aligned parallel with said handle central longitudinal axis.

13. The cap wrench of claim 11, wherein said inner prying edge of said first prying ridge and said inner prying edge of said second prying ridge define multiple serrations, said multiple serrations cooperating with the crimped edges of a bottle cap when the capped end of a bottle is inserted into said head recess.

14. The cap wrench of claim 11, wherein said end wall bottom surface defines a convex-shaped fulcrum locus that cooperates with a bottle cap when the capped end of a bottle is inserted into said head recess.

15. The cap wrench of claim 11, wherein said end wall bottom surface defines at least one raised rib, such that said at least one raised rib cooperates with a bottle cap when the capped end of a bottle is inserted into said head recess, said at least one raised rib being aligned parallel to said central longitudinal axis of said handle.

16. The cap wrench of claim 15, wherein said at least one raised rib forms a discontinuous convex-shaped profile.

17. The cap wrench of claim 9, wherein said sidewall defines a tab slot for receivably accepting a pull-tab from a metal can, said tab slot proceeding from said outer sidewall surface toward said inner sidewall surface.
